(19) United States
(12) Patent Application Publication
(10) Pub. No.: US 2007/0005685 A1
(43) Pub. Date: Jan. 4, 2007

(54) Browser-based payment system

(76) Inventors: Wunchun Chau, Bellevue, WA (US); William Pittman, Redmond, WA (US)

Correspondence Address: AZ PATENT LAW FIRM, P.O. Box 1921, Beltsville, MD, 20704, US

(21) Appl. No.: 11/465,479

(22) Filed: Aug. 18, 2006

Related U.S. Application Data
(63) Continuation of application No. 10/292,216, filed on Nov. 12, 2002, now abandoned.
(60) Provisional application No. 60/410,889, filed on Sep. 16, 2002.

(51) Int. Cl. G06F 15/16

(52) U.S. Cl. 709/203

(57) ABSTRACT

A web browser-based payment system contains a processing server, a virtual terminal comprising a computer running a browse, a virtual terminal application, and at least one Point of Sale device connected to the computer, and network connection between the processing server and the virtual terminal. The virtual terminal thus is capable of retrieving from the server the virtual terminal application for processing payment. The virtual terminal invokes an embedded plug-in component, which allows the browser to interface with the POS devices. This payment system is capable of processing payments by using payment data from the attached Point of Sale device.

### CROSS REFERENCE TO RELATED APPLICATIONS

This patent application is a continuation application of the U.S. patent application Ser. No. 10/292,216, still pending, filed on Nov. 12, 2002, which claims the priority from U.S. Provisional Patent Application No. 60/410,889, filed on Sep. 16, 2002. The entire contents of the provisional patent application and the non-provisional application are incorporated herein by their entirety.

### COPYRIGHT NOTICE AND USE PERMISSION

A portion of the disclosure of this patent document contains material that is subject to copyright protection. The copyright owner has no objection to the facsimile reproduction by anyone of the patent document or the patent disclosure as it appears in the U.S. Patent and Trademark Office patent file or records, but otherwise reserves all copyright rights whatsoever. The following notice applies to the software and data as described below and in the drawings hereto: Copyright 2006, TPI Software, Inc, All Rights Reserved.

### REFERENCE TO COMPUTER PROGRAM LISTING, COMPACT DISC APPENDIX

A compact disc in duplicate was included in the U.S. patent application Ser. No. 10/292,216, and is incorporated by reference herein in its entirety having thereon a computer program listing appendix in the ASCII uncompressed text format with ASCII carriage return, ASCII line feed and all control codes defined in ASCII, having computer compatibility with IBM PC/XT/AT or compatibles, and having operating system compatibility with MS-Windows. The compact disc, created on Nov. 10, 2002, contains the following files and sizes: Device₁₃ Setup_Page.html (369 lines, 955 words, 16380 chars), it is a device setup page; VT.css4 (4 lines, 26 words, 234 chars), VT style: VT_Check.html (116 lines, 791 words, 15050 chars), this is Virtual Terminal Page for checking for support for unidirectional devices; VT_Credit_Card.html (182 lines, 811 words, 14096 chars), Virtual Terminal for credit card payment; VT_Debit_Card.html (181 lines, 726 words, 12491 chars), Virtual Terminal for debit card payment; VT2.js (108 lines, 398 words, 3791 chars), Data validation for debit card payment; VTs.js (17 lines, 1133 words, 9667 chars), JavaScript Plug-in for Virtual Terminal credit/check payment; WebUIValidation.js (429 lines, 1340 words, 14604 chars), JavaScript Plug-in for data validation; richsolutions.js (123 lines, 363 words, 3711 chars), JavaScript Plug-in for miscellaneous input; and RichPosSetup.CAB (556 lines, 3309 words, 136838 chars), ActiveX control plug-in component.

### FIELD OF THE INVENTION

The present invention relates generally to web browser-based payment system that interfaces with one or more hardware device, and more particularly to web browser-based Point-Of-Sale (POS) payment system using hardware devices.

### BACKGROUND OF THE INVENTION

A network system for exchange of data with a hardware device is often used for processing payments in the retail industry. One example of such system is point of sale (POS) payment terminal, which is a physical device at the POS location that enables a merchant to process payment transactions using credit cards, debit cards, EBT cards, smart cards, checks and other payment methods. The terminal usually has a dialup modem connecting to a processing bank that processes payment transactions. Most of the processing banks disconnect its system from the terminal system after they process a payment transaction. Connection or reconnection is therefore normally required for each payment transaction. Most of these dialup modems, which were developed years ago, support only 1200 baud connectivity. The average time of processing a payment transaction is 30 seconds or more.

Payment terminals are usually equipped with at least a card reader for reading the data stored in the magnetic stripe of the card. Some are equipped with a pin-pad, which allows users to enter their Personal Identification Numbers (PIN) for very secure cash card transactions. Such transactions include payments made using debit cards, check cards, phone cards, prepaid gift cards, and electronic benefits transfers (EBT) method.

These payment terminals might be equipped with other hardware peripherals such as POS receipt printers, signature capture pads, cash drawers, display poles, and check readers. Because the hardware is not easily upgradeable, it is very expensive and difficult to upgrade them. Moreover, each dialup modem used in a payment terminal requires a dedicated phone line. Use of telephone lines in such wasteful manner significantly increases the operation costs of the payment terminals. The time necessary for establishing a connection and the old proprietary protocols used in the old modems limit the speed of processing payment transactions. The busier, a terminal is in processing payment transactions, the more time does it necessarily spend on reestablishing connections. Therefore, the efficiency of the payment terminals in processing payment transactions cannot be dramatically improved merely by installing faster POS modems.

A newer payment system, a web browser-based virtual terminal, emerged as the Internet became popular. This method is more economical for processing payment transactions. By using a virtual terminal, a merchant only needs an inexpensive computer with an installed web browser and any Internet connectivity to accept credit cards and other methods of payments. The computer price has been dropping constantly. The cost of software is also insignificant. Compared with proprietary hardware terminals, such virtual terminals are inexpensive to acquire and maintain. Because the application is upgradeable software, the virtual terminals can be upgraded by upgrading the application.

Many virtual terminals can share one line connecting to the Internet. The speed of processing payment transactions is greatly improved because there is no need for the virtual terminals to disconnect from and reconnect to the processing server as conventional payment terminals do. With a 56 k baud modem or broadband Internet connection, the transaction time on average may be less than 5 seconds.

However, the existing web browser-based virtual terminals do not support POS devices such as pin-pads, smart card readers, check readers, check imagers, signature-capturing pads, cash drawers, display poles, and receipt printers. Virtual terminals do not support these hardware devices because web browsers are not designed to interface with serial ports, USB ports, parallel ports, and other interface. They can only process payment transactions that do not use any of those POS peripheral devices. Their utilities are therefore limited to credit card and check (ACH) card payment methods. When a merchant processes a credit card payment, the merchant manually enters an account number and an expiration date into the data fields on the virtual terminal. While this method is the only way for processing telephone orders, it unnecessarily compromises the security of credit account information when the cardholder is available to swipe the card and unnecessarily results in a higher discount rate the merchant has to pay for using the payment system.

Most of the current virtual terminals generally support only card-not-present transactions, except that some terminals support keyboard wedge card readers partly because they use a PS2 port, which is also the port that keyboards use in computers. A keyboard-wedge card reader essentially emulates a keyboard. The user must set input focus on a particular input field and read all the key-pressing events on that field as if they all come from the keyboard. Such system requires the user to place input focus on the right data field before the card is swiped. When the user forgets to place input focus on the right field, the error may confuse the purchaser as to whether a payment is properly processed. Payment errors are undesirable, especially when the payment terminal is busy with customers. Also, the swiped-in data is displayed on the terminal monitor as the data is read in, which compromises the security of account information.

Moreover, existing virtual terminals are unable to support payment transactions using online debit cards and EBT methods because they cannot provide the required hardware-based encryptions. For example, a pin-pad employs very strong encryption method to encrypt the PIN data before the data is transmitted to the processing bank. To ensure maximum security, all encryptions must be done by hardware. It is impossible to design a pin-pad capable of software-based encryption that meets the security requirement.

### SUMMARY OF THE INVENTION

The primary object of the present invention is to develop a browser-based payment system that can interface with hardware devices. Another object of the present invention is to provide a browser-based payment system that processes retail card present payment transactions and online debit transactions. Yet, another object of the present invention is to provide a browser-based payment system that is able to accept multiple payment methods. While the browser-based payment system is primarily for processing payment transactions, its utility is not limited to payment transactions. For example, the same browser interface used in the system can be used to interface with a barcode scanner and make the browser an inventory control system. It may also be used to manage resources through interfaced devices.

The browser-based payment system of the present invention includes a web server (such as one run by a payment gateway company), a computer running a browser, a virtual terminal application, a plug-in component in the browser and at least one Point of Sales device.

The computer is connected to the server through a private or public network such as Internet/lntranet using any of commonly used network protocols. The POS devices attached to the payment system include at least one selected from the group consisting of pin-pad, magnetic stripe card reader, smart card reader, gift card reader, signature capture pad, check reader, check imager, pole display, receipt printer, cash drawer, bar code scanner, fingerprint reader, and iris scanner. The computer may also be attached to non-POS devices and peripherals. All main interface functions between the browser and POS devices are accomplished by using a plug-in component that is automatically loaded and executed by the browser.

The plug-in component and virtual terminal application used in the present invention originally reside in any proper directories in the web server maintained by the processing gateway. When the client computer requests the Virtual Terminal Page by calling a proper URL address, the web server automatically downloads the application and the plug-in component to the computer. The browser running the virtual terminal application can automatically identify the POS devices and configure for them. If the browser is unable to identify the device, the user can use a setup page, which is part of the virtual terminal application, to manually configure the device. The information that may be changed on the setup page includes baud rate, data bits, and hardware handshake. Once configuration is completed, the page stores the information about configured devices in a cookie in the client computer. This information is used by the virtual terminal application to interface with the POS devices in subsequent operations. Reconfiguration is necessary only if the devices are changed or modified.

The browser-based payment system of the present invention provides merchants the same convenient and economical payment-processing method as the web browser-based virtual terminal method while it also allows them to process card present transactions, accept electronic checks, smart cards, gift and loyalty cards, debit cards, and EBT cards, scan bar code, scan fingerprints and iris, capture signatures and check images, interface with cash drawers and display poles, and print receipts or records at POS thermal printers.

### BRIEF DESCRIPTION OF THE DRAWINGS

FIG. 1 illustrates the architecture of the browser-based payment system;

FIG. 2 illustrates the steps for processing a payment transaction;

FIG. 3 illustrates the setup page for a pin-pad;

FIG. 4 illustrates the setup page for a serial port card reader;

FIG. 5 illustrates credit card data with track 2 data hidden;

FIG. 6 illustrates the amount and other data for processing in a credit payment transaction;

FIG. 7 illustrates a receipt from the web server;

FIG. 8 illustrates a receipt being printed;

FIG. 9 illustrates debit sale with encrypted PIN number;

FIG. 10 illustrates a debit sale form and a receipt;

FIG. 11 illustrates a check to be drafted;

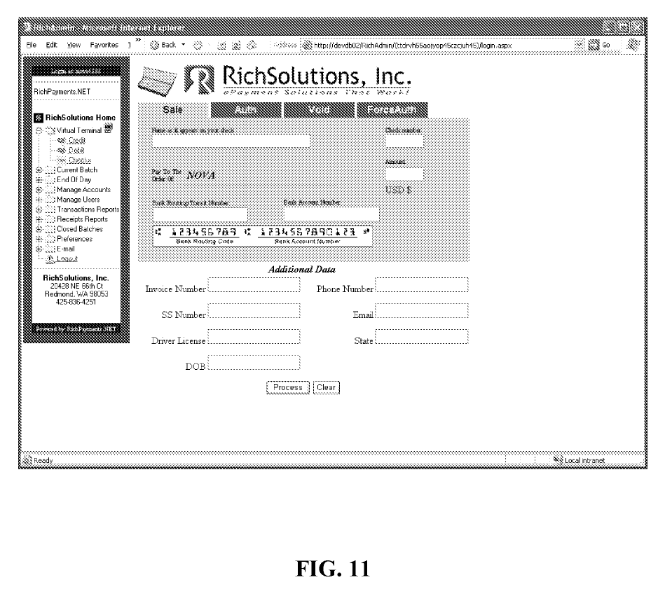

FIG. 12 illustrates virtual terminal's interface with a unidirectional POS device emulating keyboard input;

FIG. 13 is a flowchart showing the steps of a Finite State Automata method;

FIG. 14 illustrates the virtual terminal's interface with a unidirectional device using Finite State Automata;

FIG. 15 illustrates the virtual terminal's interface with a unidirectional device such as a serial port card reader;

FIG. 16 illustrates the virtual terminal's interface with a bidirectional device such as a PIN pad; and

FIG. 17 illustrates virtual terminal device setup sequence.

### DETAILED DESCRIPTION OF THE INVENTION

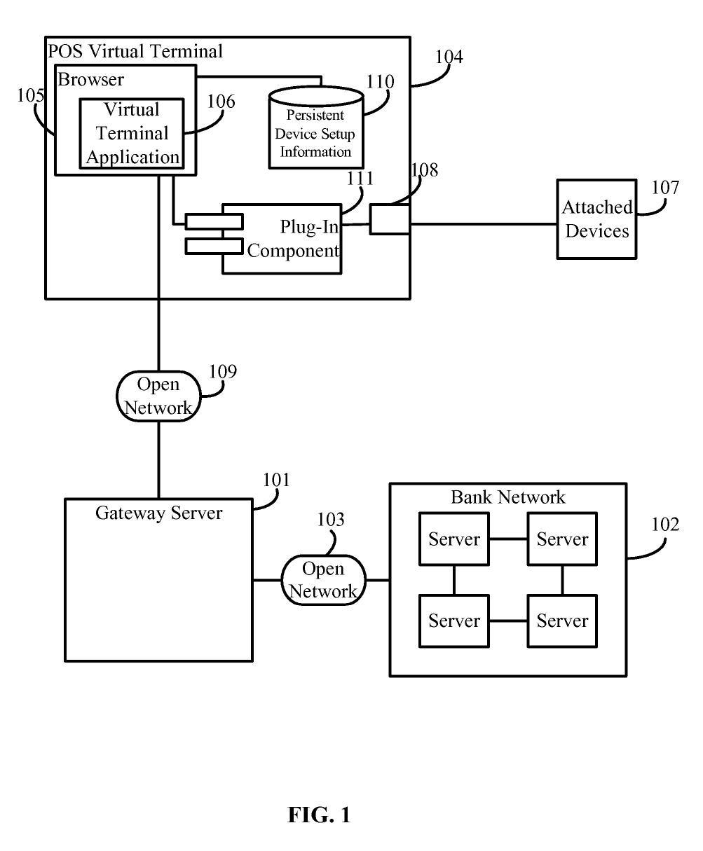

The browser-based payment system of the present invention (FIG. 1) comprises a web server 101 (also known as processing server) connecting to bank network 102 through secured connection 103, and a virtual terminal comprising a client computer 104 running a browser 105, a virtual terminal application (or Virtual Terminal Page) 106 (which also includes the plug-in component 111 and persistent device setup information 110), and one or more POS devices 107 connected to the computer 104 through serial port, USB port or parallel port 108. The client computer 104 is connected to the processing gateway server 101 through another network connection 109. The computer 104 uses persistent device setup information 110 stored in a cookie and a browser plug-in component 111 to establish an interface with the attached devices 107. The connection 109 may include a private or public network such as Internet, using any of the available lines such as dialup phone lines, leased phone lines, DSL, cables, and wireless. The browser 105 may be any of industry standard HTML-, XML-, WML-rendering applications, and the payment system may use any Internet protocol for secured data transmission.

Data is exchanged between the client computer 104 and the web server 101 in the Hyper Text Transfer Protocol format (HTTP) using any local or wide area network protocol that can support that format. It can also be accessed locally on the same machine or network share.

The client computer 104 that hosts the virtual terminal may be of any type as long as it can run the browser under a proper operating system. Thus, computers using Intel processors, computers using Apple operating systems, and computers running open source operating systems are all suitable hosts of the virtual terminal. Likewise, the processing server 101 in the gateway may be any type of hardware as long as it is capable of communicating with the client computer by using the same communication protocol such as HTTP, FTP, or otherwise. Also, the browser-based payment system may be constructed over a LAN, WAN, or other equivalent private network as part of the network connection 109. The plug-in component 111 provided in the Compact Disc was tested for many popular hardware types such as IBM compatible computers, popular servers, and mainframe computers under proper operating systems. The plug-in component 111 also works under various versions of Microsoft Windows operating systems. The plug-in component 111 can be modified for computers of other types. While a secured connection between the gateway and the payment-processing network is necessary for the safety of payment transactions, the browser-based payment system works without using any security feature. The plug-in component 111 is compatible with all current versions of Microsoft Internet Explorer web browsers discussed above.

Browser 105 throughout this disclosure means a hypertext rendering application that is in compliance with any of the standard HTML, SGML, XML, and WML specifications and other equivalents. Examples of the browsers include, but not limited to, Microsoft Internet Explorer, Netscape, AOL browsers, Mozilla, and Konqueror. Any of the available HTML-, XML-, and WML-rendering browsers may be used in the present invention. One of the browsers is a mode browser that was made available for the public on Jan. 15, 1992 via telnet. The first popular browser was NCSA Mosaic, which supported only HTML 1.0. This browser was released for all common platforms such as X, PC/Windows, and Macintosh in September 1993. Today, many browsers are available in the market. The dominating ones are Internet Explorer from Microsoft, Netscape and AOL browsers from AOL Time Warner, and the open-source browser Mozilla. All current versions of these browsers support both HTML and XML.

All browsers support some forms of functional extensions by accepting plug-in components. A plug-in component is used by web browser to perform a task the browser is not capable of doing. Most plug-ins are provisioned by web servers over the Internet automatically and installed in the client computer with little or no user intervention. All browsers support some forms of macro or scripting languages that provides many possibilities. The dominating scripting languages for browsers are JavaScript and VBScript. Scripts in those languages embedded in an HTML or XML page can respond to user events such as mouse-clicks, form input and page navigation.

The source code in the attached Compact Disc includes reference implementation of the browser-based payment system. The Virtual Terminal application contains Device_Setup_Page.html (a device setup page), VT.css (controlling the virtual terminal style), VT_Check.html (check payment form and interface with unidirectional device such as check reader), VT_Credit_Card.html (a credit card payment form and interface with unidirectional device such as card reader and receipt printer), and VT_Debit_Card.html (debit card payment form and interface with both unidirectional device such as card reader and receipt printer and bidirectional device such as pin-pad). Plug-in component includes VT2.js (a JavaScript plug-in for debit card reader), VTs.js (JavaScript plug-in for VT credit and check payment), WebUIValidation.js (JavaScript plug-in for validating input data), richsolutions.js (a JavaScript plug-in for miscellaneous input), and RichPosSetup.CAB (ActiveX control plug-in for interface with POS devices through serial port and USB port).

The web browser 105 executes the plug-in component 111 in the client computer at runtime. The plug-in component 111 is capable of interfacing with any of the hardware devices 107 attached to the computer. The client computer 104 running the browser communicates with the POS devices 107 in two modes: unidirectional or bi-directional, depending upon the devices and the nature of payment transactions. Unidirectional devices include all serial port or USB devices. This class of devices includes serial port card reader, keyboard-wedge card reader (using either PS2 or USB), check reader, and display pole. Bi-directional devices include, among others, pin-pad, check imager, and signature capture pad.

The keyboard-wedge device emulates key-pressing events when it reads the data from the cards. The device sends back a series of the key-pressing events to the client computer 104. Since the browser can handle keyboard input, this method is easy to implement. To distinguish a key-pressing event from the keyboard and a key-pressing event from the card reader, a method called finite state automata is used.

The interface of the client computer 104 with the POS devices 107 is implemented by a JavaScript script and the plug-in component 111. The JavaScript is provided in the compact disc attached to this disclosure. The JavaScript script is a small script program embedded in the HTML code and executed by the browser at runtime. There is neither external dependency nor software to install other than the browser itself. The JavaScript is capable of interfacing with POS devices such as keyboard wedge card readers, keyboard wedge check readers, USB keyboard emulated card readers and USB keyboard emulated check readers. It is also capable of interfacing with POS receipt printers directly.

Browser's interfacing with serial port devices such as serial port card readers, pin-pads, check readers, check imagers, signature capture pads and other POS devices is achieved through an embedded browser plug-in. This browser plug-in is a software program that is provisioned to the client computer automatically the first time the client computer 104 accesses the virtual terminal application of the processing server 101 at gateway. All subsequent interactions with the plug-in occur locally at the client computer 104. After the plug-in is installed, the web server 101 will not download the plug-in again in subsequent connections unless the web server 101 has a newer version of the plug-in. A newer version will automatically be provisioned to the client computer 104 just like the old plug-in was the first time.

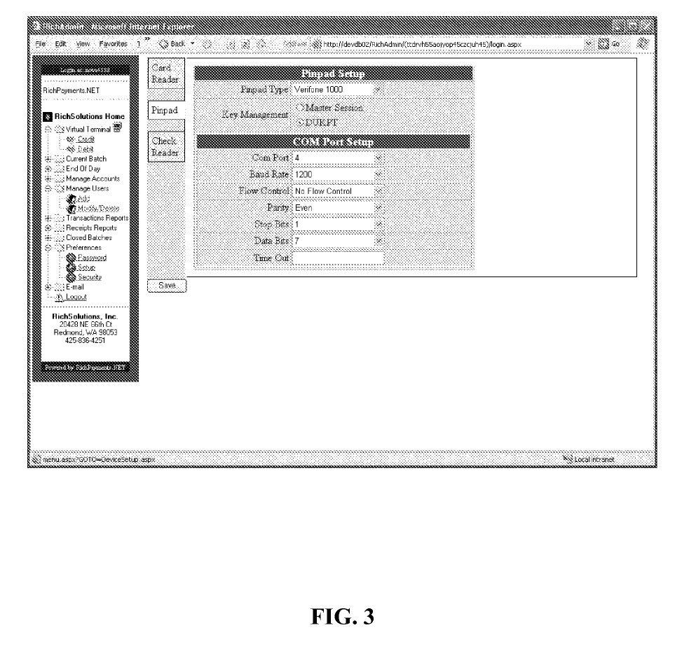

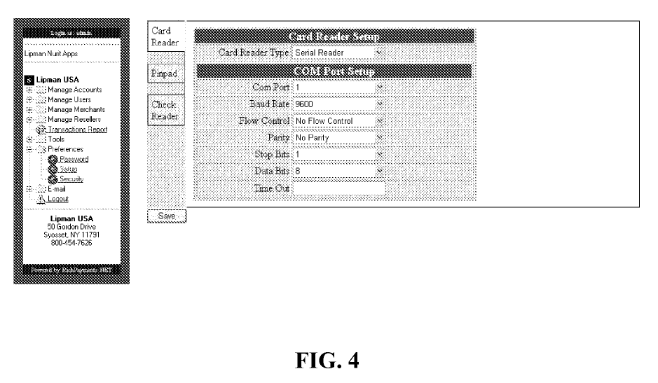

The virtual terminal application 106 has a hardware device setup page (e.g., persistent device setup information in FIG. 1) (FIGS. 3, 4). It can be conveniently placed anywhere in virtual terminal application 106 or other accessible folders of the merchant account maintained in the web server 101. After setting-up of the POS devices such as card readers and pin-pads is properly performed, the web server 101 pushes a cookie to the browser 105 containing the device information in the client computer. Cookie is a method (defined in the HTTP protocol specifications) to store information in the format of name/value pairs on client computers, and cookie is accessible by both the web browsers and the web servers. The information in a cookie is unique to the computer and this property allows each computer to have a different device setup even if they all share the same merchant account.

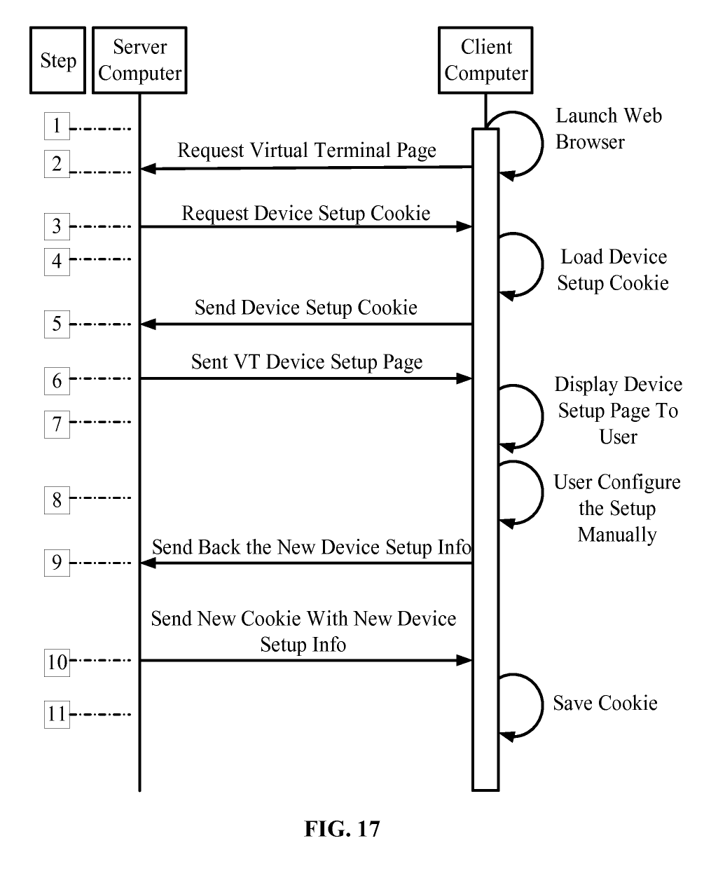

The detailed events associated with the setup operation are shown in FIG. 17. When the Setup page is loaded, it checks the client computer to determine whether there is a cookie containing the device setup information 110. If so, the information will be used in all subsequent pages of the virtual terminal application to interface with the devices 107.

A user can setup the POS hardware devices 107 using the virtual terminal hardware setup page. The user can open the Setup page and update the device setup information anytime. The device setup information is specific to the client computer where the cookie is stored. The cookie stores the following information for each of the POS devices: device type and device-specific information (e.g. Key Management for a pin-pad) (FIGS. 3, 4). The Setup page also shows COM port setup. For a serial port device, the device information includes COM port, baud rate, flow control, parity, stop bits, data bits, and timeout. After setup is done, the values selected or entered by the user can be saved by clicking the Save bottom on the left bottom of the setup page as shown in the FIG. 3.

When a user wants to process a payment using a client computer 104, the user opens the Virtual Terminal Page using a browser. The web server 101 then retrieves the cookie from the client computer 104. If the cookie contains valid device setup information, JavaScript and ActiveX control objects, which are software components that provides interface with other hardware, are embedded in the Virtual Terminal Page or provisioned to the client computer 104 if the client computer doesn't already have these objects. The method for this embedding is to include links on the Virtual Terminal Page to the location of the plug-in objects. The browser then first checks if the plug-in objects defined in those links are already in the client computer 104. If those objects are found, the browser then loads them from the client computer 104. If the browser cannot find those objects in the client computer, it will automatically connect to the location pointed by those links to download them.

The plug-in object, in the form of an ActiveX control, opens all the appropriate serial ports according to the device setup information and then spawns a worker thread to listen on each port. When data is ready from a port, the worker thread parses the data and then raises an event to the browser. The JavaScript inside the browser handles the events and fills the data fields with the data accordingly. The data vary, depending on the POS devices that generate the data. A card reader may present card data such as Track 1 and Track 2 data. Cardholder's name, expiration date and card number can be parsed from Track 1 data. A check scanner may present data such as MICR that composes transit/routing number, account number and check number.

For a POS device such as a USB keyboard emulated card reader, a check reader and a keyboard wedge reader, another JavaScript embedded on the Virtual Terminal Page is listening for key-pressing events and parsing keystrokes using a finite state machine (as more fully explained later). When data is ready, this script fills the data fields accordingly.

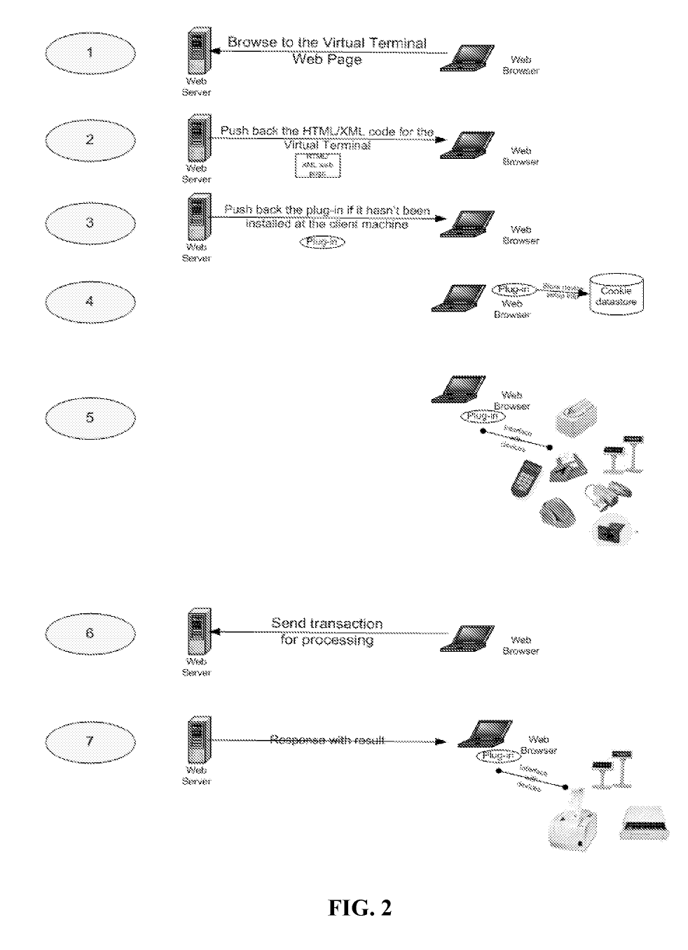

The steps (shown in FIG. 2) required for the virtual terminal to process a card-present transaction are as follows.

1. A user of the payment system opens the Virtual Terminal Page by entering the correct the URL in the browser;

2. The web server downloads the virtual terminal application in HTML/XML code to the web browser in the client computer, displaying the Virtual Terminal Page;

3. The web server downloads a plug-in component if the web browser does not have one yet;

4. A plug-in is downloaded to the client computer, which automatically configures the device setup information and stores the information as a cookie in the cookie data store; alternatively, the setup may be done manually and setup information may be saved by clicking a save bottom;

5. The plug-in component interfaces with the POS devices including a card reader, by unidirectional or bidirectional mode;

6. Payment data is sent and parsed by the browser in one of the two methods: (a) if the card reader is a keyboard wedge card reader or a USB keyboard emulator card reader, the magnetic stripe data on the card is passed back from the card reader as a series of key-pressing events, and the key-pressing event is then parsed using a finite state automata method and data is extracted in real time to fill appropriate fields on the Virtual Terminal Page; (b) if the card reader is a USB, serial port reader or other type of reader, an ActiveX component invoked by the Virtual Terminal Page interfaces with the card reader directly using its native interface protocol, extracts the swiped in data, and places it in the data fields on the Virtual Terminal Page with sensitive track data being stored in hidden fields (before the data is sent, the user need to submit a payment-submission button to send the payment data to the web server); and

7. The web server sends the client computer a receipt of the payment that will be displayed on the Virtual Terminal Page.

A. Using Keyboard Wedge Card Reader and a Finite State Automata

According to this embodiment of the present invention, the browser-based payment system is same as the system discussed above except that the virtual terminal is connected to a keyboard wedge card reader and the plug-in component 111 is a JavaScript.

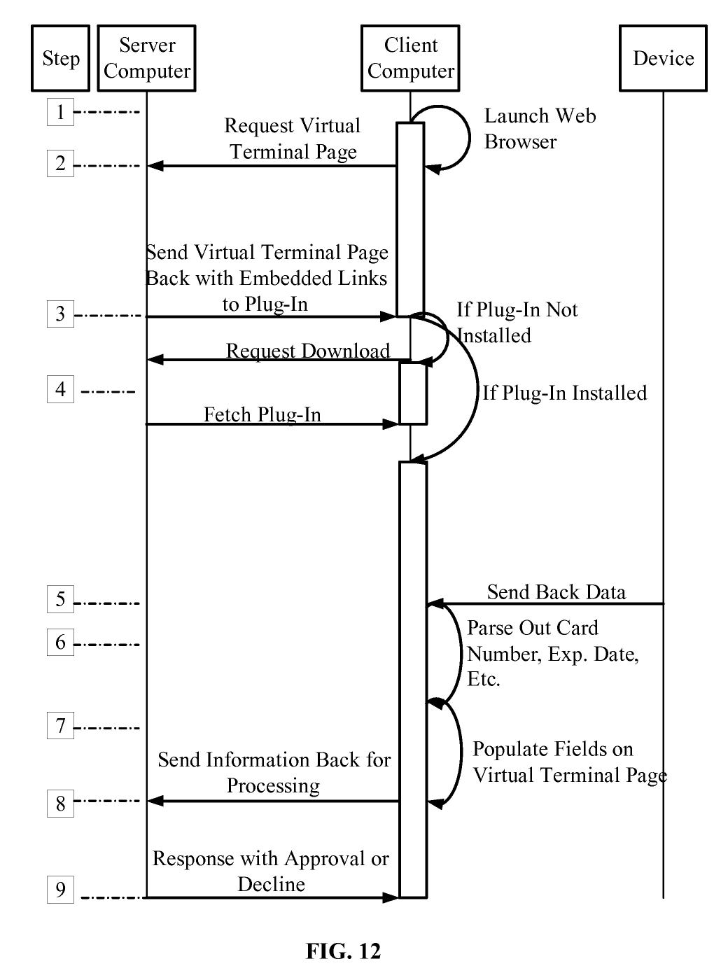

Detailed information on the virtual terminal's interface with a unidirectional POS device is shown in FIG. 12. The browser is launched from the client computer 104 (Step 1), which sends a request for the Virtual Terminal page 106 to the web server 101 (Step 2). The server 101 sends to the client computer the Virtual Terminal page with embedded links to the plug-in 111 (Step 3). If the plug-in component 111 is installed, then the client computer 104 uses the installed plug-in component 111. If no plug-in component is installed, the client computer 104 requests a plug-in component download from the web server 101 (Step 4). The Virtual Terminal page 106 is embedded with plug-in objects, and they are put in as JavaScript code and ActiveX control. This process is automatically done by the browser.

When data from the device 107 is ready, the device 107 sends the data back to the client computer 104 (Step 5). The data may be acquired by the device 107 when a user swipes a card through the device 107 (e.g., a card reader). Upon receiving data from the device 107, the client computer 104 parses out card number, expiration date, and other information (Step 6) and populates the data in the fields of Virtual Terminal page (Step 7) by the running of the JavaScript code embedded on the Virtual Terminal page. Once data is ready and the appropriate fields are filled, the client computer 104 sends the data back to the web server 101 for processing (Step 8). Once the web server 101 processes the data, it sends the client computer 104 a code/message indicating approval or a decline (Step 9).

In this embodiment of the present invention, an effort was made to eliminate the need for moving input focus to the appropriate field before the user swipes the card. In order to parsing data correctly, the virtual terminal needs to correctly fill data from the card into the data fields of the Virtual Terminal Page or their associated variables. Each bankcard can have up to three tracks (ISO 3554). The top one is 210 bits per inch (“BPI”) and has 7 bits per char (including parity). It has a total 79 alpha-num chars. The second track has 75 BPI with 5 bits per char (including parity). It has 40 digits (chars). Most bankcards use only tracks 1 and 2. Each track data starts with a distinct char “%” (37), “;” (59), or “+” (43), respectively for Tracks 1, 2, and 3. Each has the same end char, “?” (63). The data string originated from a banking card follows format “start char, card-data, and end char”. Card data in different fields are separated by “ˆ”. The end of the data string is a carriage return. A sample track data is “% BCardNumberˆLastname/FirstnameˆExpdateAndTrackData?;CardNumber=ExpdateAndTrackData?CR”.

The browser 105 parses all data from key-pressing events through finite state automata (FSA) that determine whether the key-pressing events belong to a track data from the card reader. A finite-state automaton is a standard methodology to describe a logical machine that can occupy one of a number of states. FSA is initially assumed to be in its start or initial state and can move to other states. Input to the automaton can cause a change in its state, which is also known as a transition. States in an FSA may be accepting (“final”) and non-accepting. An input string that brings the automaton to an accepting state is valid while a string that brings the automaton to a non-accepting state is not. The input to an FSA may be a series of events, and one or more events can be associated with each transition. This makes finite-state automata convenient for modeling system execution. As events occur, the automaton moves from state to state, providing a trace of the execution.

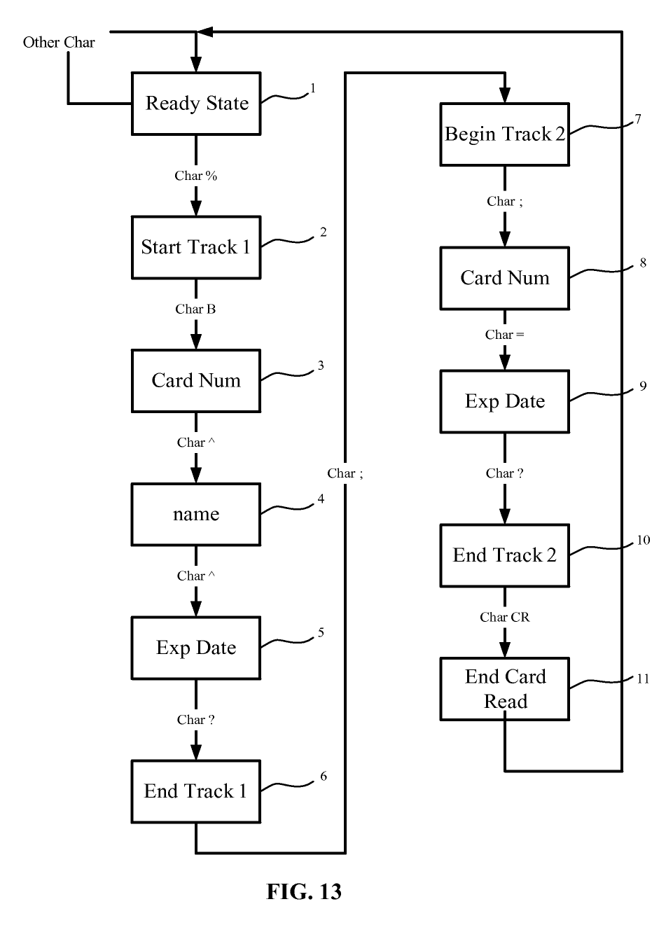

Since a keyboard wedge card reader emulates keyboard action with each character on the magnetic strip data responding to a key, each key-pressing event will trigger the FSA (for example, typing “abc” will trigger the FSA 3 times, “a” passes through FSA, then followed by “b”, then followed by “c”), the FSA then bases on the current state and the key pressed to decide what the key-pressing event is for. (FSA is implemented as a nested if . . . then . . . else . . . statements, the FSA has a current state that keeps track of where the current ‘position’ or ‘state’ it is in, the incoming character will go thru the nested if . . . then . . . else . . . statements, base on the outcome of the if . . . then . . . else . . . statements and the current state, the FSA make the following decisions: the outcome of this input and the next state it should change its current state to.) FIG. 13 shows that a FSA that is capable of processing track data that is from the magnetic stripe:” % BCardNumberˆLastname/FirstnameˆExpdateAndTrack Data?; CardNumber=ExpdateAndTrackData?CR”.

The process of parsing data for three tracks of a bankcard is shown in FIG. 13. Once a card is swiped, the device 107 sends the card information to the client computer 104. The client computer 104 parses out the data and reads a character. Track 1 is checked to determine if it is in a ready state. If track 1 is ready (Step 1), the FSA advances to the next step (Step 2). The client computer 104 then reads the card number (Step 3), the card name (Step 4), and expiration date (Step 5) from track 1. When the data from track 1 is obtained, the client computer 104 signals the end of track one (Step 6) and begins track 2 (Step 7). The client computer 104 reads the card number (Step 8) and expiration date (Step 9) from track 2. When the data from track 2 is read, the client computer 104 signals the end of track 2 (Step 10). Once track 1 and 2 are read, the client computer 104 ends the read for that card (Step 11) and checks for the next character.

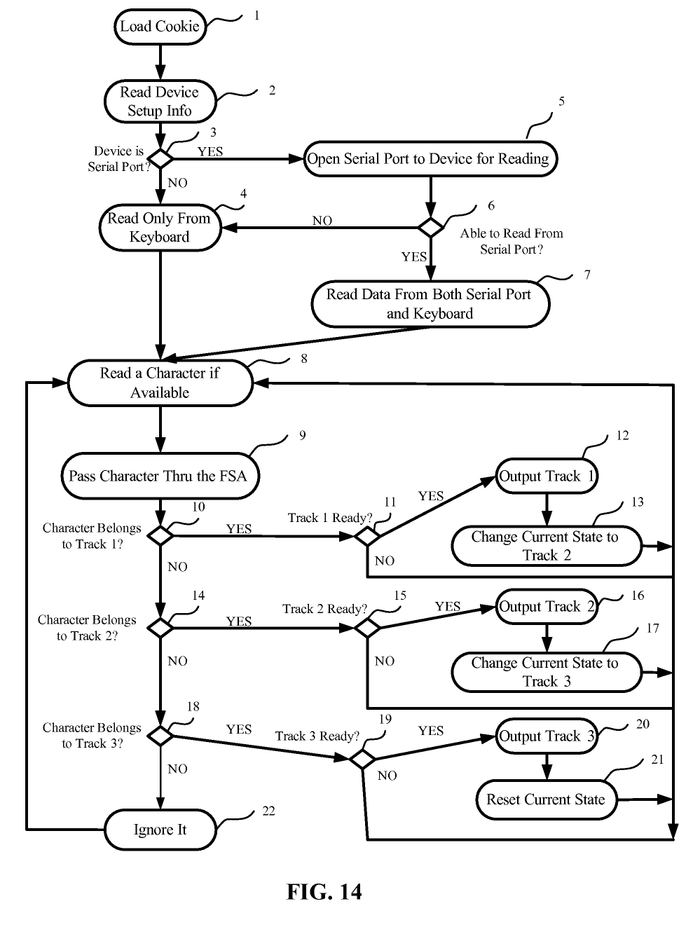

The detailed implementation of the Virtual Terminal Page to interface with a unidirectional device using FSA is illustrated in the FIG. 14. When the Virtual Terminal page 106 is fetched from the web server 101 by the browser, the web page contains a command instructing the browser 105 to load a cookie (Block 1) in the form of name/value pairs from the client computer 104 where the device configuration information 110 is stored. The Virtual Terminal page 106 then reads device setup information 110 (Block 2). If the device configuration information read from the cookie specifies a COM (serial) connection (Block 3), the Virtual Terminal page 106 attempts to open a serial connection using the port specified by the cookie (Block 5). If the device configuration information 110 specifies a Key Board feed only (Block 4), no serial connection is attempted, and the Virtual Terminal page 106 will accept and input from the system's keyboard feed. If the device 107 is configured for a serial device but the device isn't functioning or is not present (Block 6), the Virtual Terminal Page 106 then accepts data from the keyboard (Block 4). Otherwise, the virtual terminal read data from both serial port and keyboard (Block 7).

The client computer 104 then checks the device 107 to see if a character is available (Block 8). If it is, the client computer 104 reads it and passes the character through to the FSA (Block 9) to determine if the character belongs to track 1, 2 or 3. If the character does not belong to any of these tracks, the Virtual Terminal ignores it (Block 22) and moves to the next character until no more character is available.

If the character the FSA reads from the device 107 belongs to track 1 (Block 10), the Virtual Terminal then determines if track 1 is ready (Block 11). If track 1 is not ready, the Virtual Terminal reads the next character if it is available (Block 8). If track 1 is ready (Block 11), it outputs track 1 (Block 12) and changes the current state to track 2 (Block 13). If the next character that the FSA reads from the device belongs to track 2 (Block 14), the Virtual Terminal determines if track 2 is ready (Block 15). If track 2 is not ready, the Virtual Terminal reads the next character if it is available (Block 8). If track 2 is ready (Block 15), it outputs track 2 (Block 16) and changes the current state to track 3 (Block 17). If the character that the FSA reads from the device belongs to track 3 (Block 18), the Virtual Terminal determines if track 3 is ready (Block 19). If track 3 is not ready, the Virtual Terminal reads next character (Block 8). If track 3 is ready (Block 19), it outputs track 3 (Block 20) and resets the current state (Block 21). A similar constructed FSA can be constructed to parse MICR data from a check scanner and a PIN block from a PIN pad.

When a user processes a payment transaction in the normal course of business, the payment system processes the payment in the following steps:

1. A user of the payment system opens the Virtual Terminal Page by entering the correct URL in the browser;

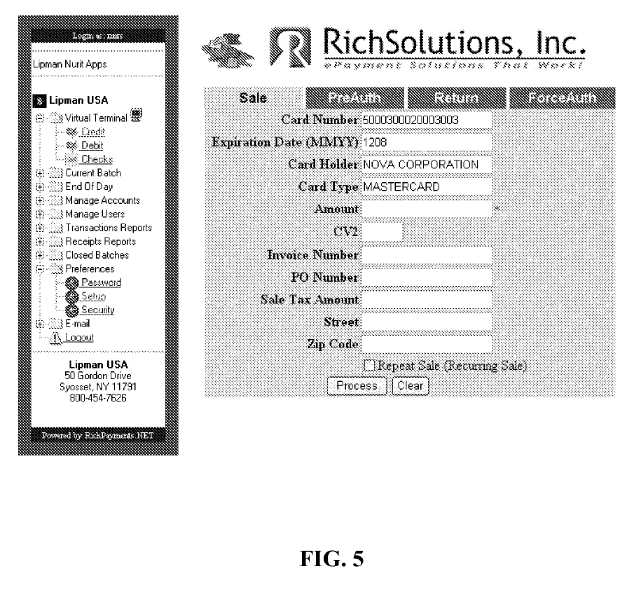

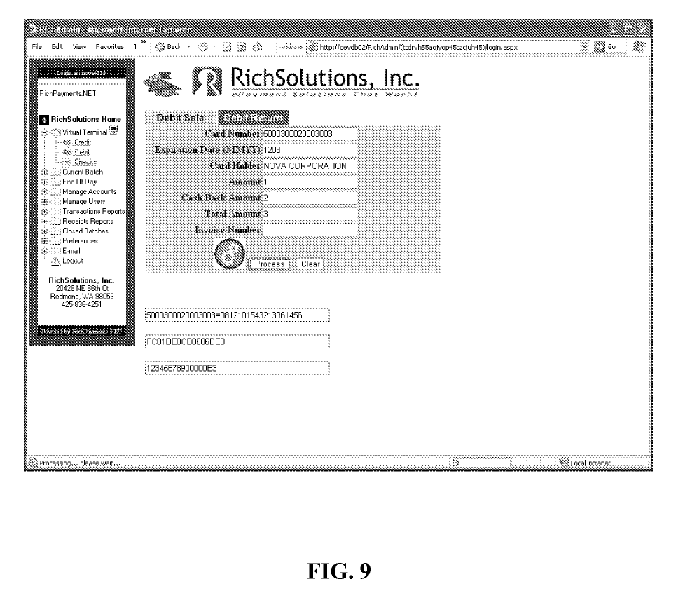

2. The user may select a payment method under the Virtual Terminal Page: credit, debit, and checks (track 2 data is not displayed) (FIGS. 5, 9);

3. The Virtual Terminal Page shows necessary fields such as name and address of the cardholder without showing sensitive information such as credit card number, expiration date, and PIN (FIGS. 5, 9);

4. The user swipes a card against a card reading device, which may be a keyboard wedge card reader, a USB card reader, a serial port card reader or any card reader attached to the client computer;

5. Parsing the data by the browser. If the reader is a keyboard wedge card reader, the key-pressing event is parsed using a finite state automata and data is extracted in real time to fill appropriate fields on Virtual Terminal Page;

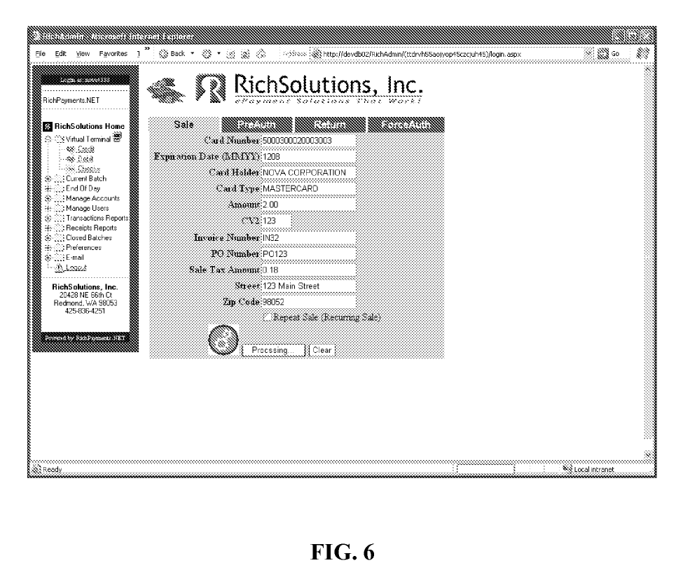

6. All tracks of data (FIG. 6) are sent to the web server for processing;

7. The web server then contacts the bank server to determine if the payment is approved and sends a code of approval or a message of denial;

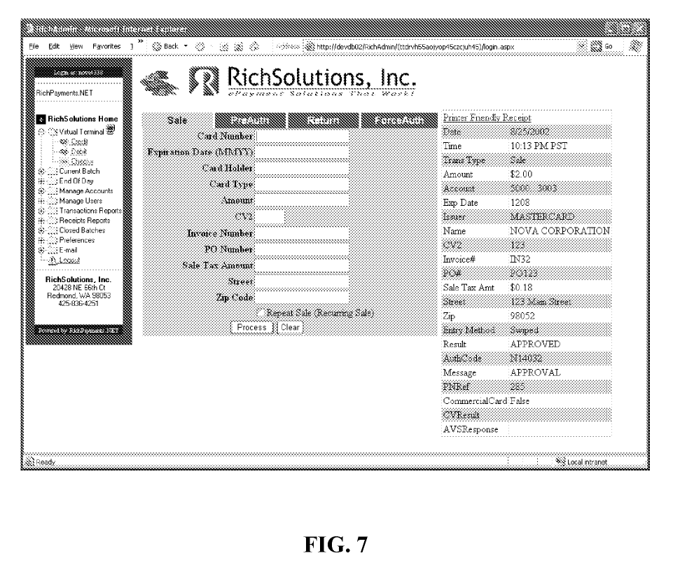

8. The web server then sends the client computer a receipt that is displayed on the Virtual Terminal Page (FIG. 7); and

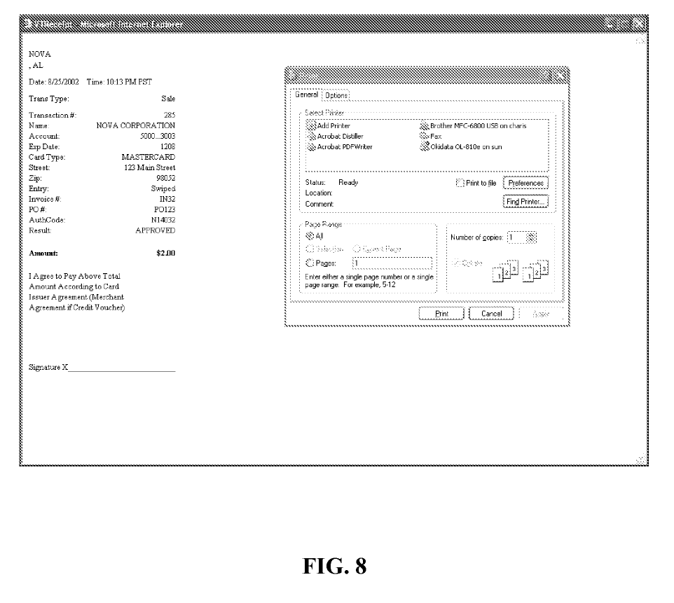

9. The user then prints the receipt using the printer attached to the client computer (FIG. 8).

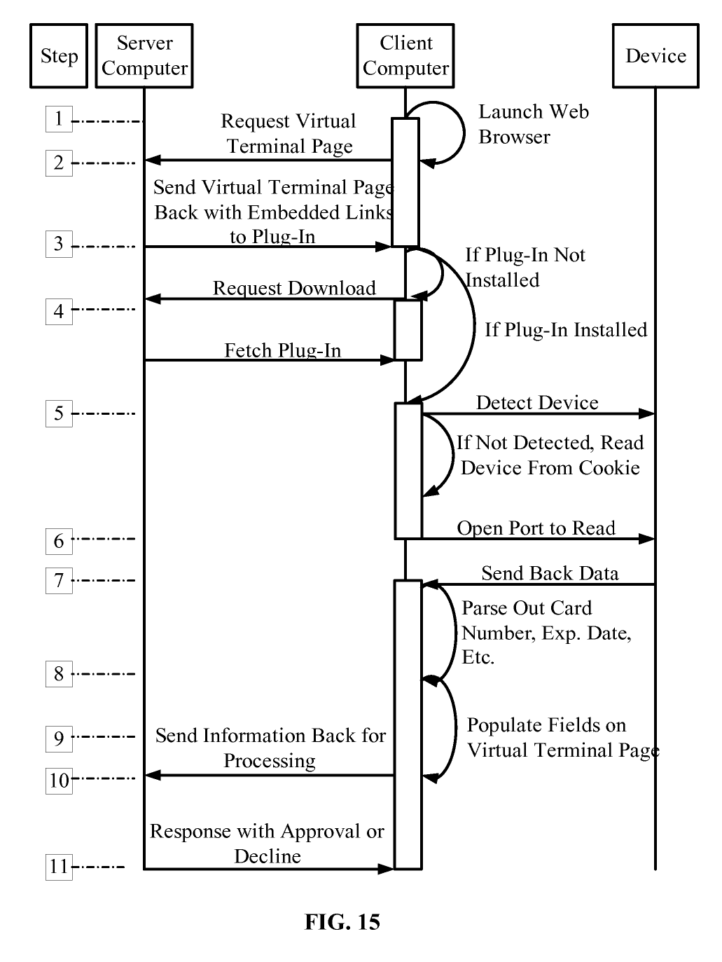

The steps for processing debit, EBT and other transactions using unidirectional POS devices are similar. Details concerning the virtual terminal's interface with a unidirectional POS device are shown in FIG. 15.

The web browser 106 is launched from the client computer 104 (Step 1), which sends a request for the Virtual Terminal Page 106 to the web server 101 (Step 2). The web server 101 sends the Virtual Terminal Page 106 to the client computer with embedded links to the plug-in component 111 (Step 3). If the plug-in component 111 is installed, then the client computer 104 uses the installed plug-in component 111. If no plug-in component is installed, the client computer 104 requests a plug-in component download from the web server 101 (Step 4). The Virtual Terminal Page 106 is embedded with plug-in component objects, which are put in as JavaScript code and ActiveX control. This process is automatically done by the browser.

After the plug-in component 111 is installed, the client computer 104 tries to detect the device (Step 5). If a device 107 is detected, the client computer 104 opens the device and reads data from the device (Step 6). A cookie storing the device information is saved at the client computer 104 after a user configures the device using the Virtual Terminal device setup page. If no device is detected, the client computer 104 then reads the device from the cookie, and opens a port to read from the device (Step 6). Unidirectional devices, such as a card reader, are usually easy to detect and all one has to do is to open a port for reading.

When data from the device 107 is ready, the device sends the data back to the client computer 104 (Step 7). The data may be acquired by the device 107 when a user swipes a card through the device. Upon receiving data from the device 107, the client computer 104 parses out card number, expiration date, and other information (Step 8) and populates the data in the fields of Virtual Terminal Page (Step 9) by running the JavaScript on the Virtual Terminal Page. The client computer 104 sends the data back to the web server 101 for processing (Step 10). Once the web server 101 processes the data, it sends the client computer 104 a code of approval or a message of denial.

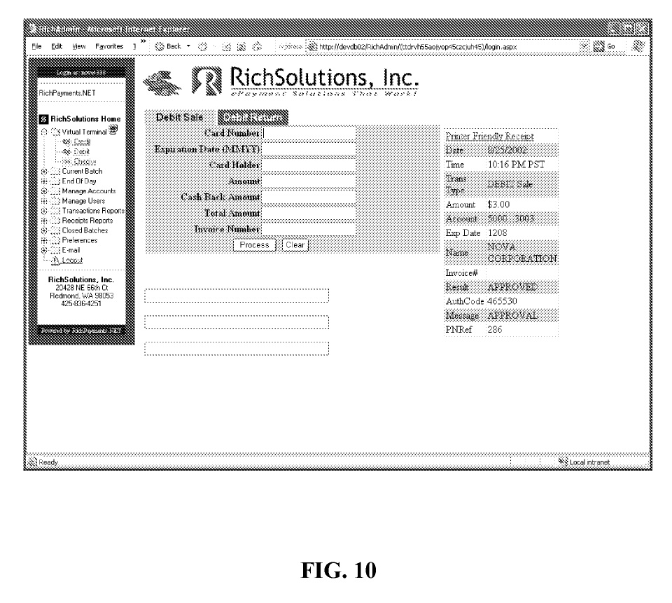

When the virtual terminal processes a payment made by a debit card, the virtual terminal will not display the track 2 data and PIN number (FIG. 9). The result from making a debit card payment is shown in FIG. 10.

B. Using a Bi-directional POS Device

This embodiment of the present invention has the same hardware architecture as the above browser-based payment system. It differs in its interface with the POS devices 107 and the plug-in component 111 that runs the interface. For bi-directional devices using serial, parallel, or USB ports, the browser 105 has to spawn a separate thread that listens on the read event fired from the devices. Spawning a separate thread is not permitted because the browser 105 usually has very tight control on security. To overcome this security constraint, the plug-in component 111, from which a thread can be spawn, has to be “trusted” by the browser 105 and has to implement a series of interfaces. To gain trust from the browser 105, it must be digitally signed by a recognized certificate authority (such as Verisign or Thawte). Once the plug-in component 111 is trusted by the browser 105, it can access any resources on the computer including any serial, USB and parallel devices.

Internet Explorer's default security settings require that any plug-in component be digitally signed by a certificate authority before Internet Explorer executes the plug-in component. A digital signature provides a way to verify the contents of a file and its responsible source.

Digital signature is a means of ensuring that a file's contents have not been altered since it was first made available for download. It is not sufficient to digitally sign the component itself, the one who signed the signature also needs to be verified by a recognized certificate authority such as Verisign or Thawte. A software developer can provide a digital signature by purchasing a certificate from a certificate authority. A certificate authority is a company that validates the software developer's identity and issues a certificate to the developer. The certificate contains a digital signature and is an indication of the developer' credentials. The process of signing a digital signature is well known. Those certificate authorities maintain web sites that contain step-by-step instructions for applying and using digital signatures.

When the browser-based payment system is connected to a device (which is a device 107) that requires a bidirectional communication, the plug-in component 111 must be in the form of a compiled native binary that is trusted by the browser 105. Such a plug-in component may be written in any programming language such as C or C++ and is compiled for a given type of computer and operating system. By using the trusted binary, the browser 105 is able to freely access any resource of the computer. Once the trusted binary is loaded and executed by the browser 105, it spawns two threads, one being responsible for sending data to the device 107 and the other for reading data from the device 107. This multi-threaded asynchronous read/write schema is crucial to the performance of the browser-based payment system. Without the multi-threaded asynchronous operation, the browser 105 tends to hang when its main thread is dedicated to communicating with the device 107. The multi-thread asynchronous operation enables the browser 105 to interact with user while it is at the same time interface with the device 107.

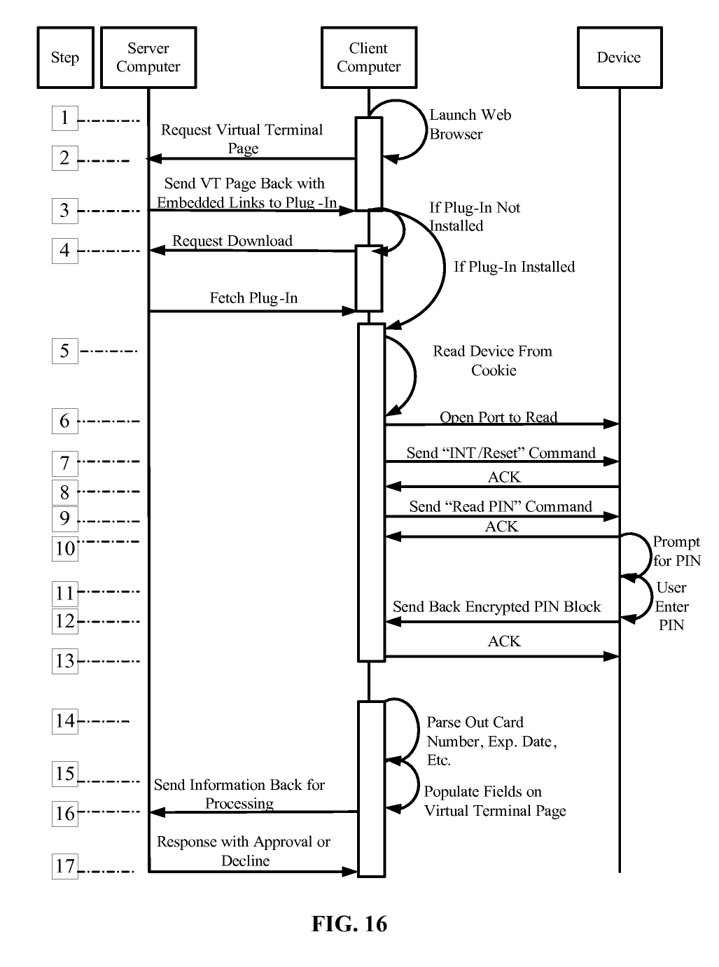

Details concerning the virtual terminal's interface with a bidirectional POS device such as PIN pad are shown in FIG. 16. The web browser 105 is launched from the client computer 104 (Step 1), which sends a request for the Virtual Terminal Page to the web server 101 (Step 2). The web server 101 sends the Virtual Terminal Page to the client computer 104 with embedded links to the plug-in component 111 (Step 3). If the plug-in component 111 is installed, the client computer 104 will use the installed plug-in component 111. If no plug-in component is installed, the client computer 104 will request a plug-in component download from the web server 101 (Step 4). The Virtual Terminal Page is embedded with plug-in objects, which are in the form of JavaScript code and executable ActiveX control. This process is automatically done by the browser.

A cookie storing the device information resides at the client computer 104 after the user configures the device 107 using the Virtual Terminal device setup page (FIG. 16). The client computer 104 reads device information from the cookie (Step 5) and opens a port to read and write to and from the device 107 (Step 6). When the device is a bi-directional device, such as PIN pad, it is not easy to detect the device because each bi-directional device has a different protocol. So, it is necessary to setup the device 107 manually by assigning device type and communication method. While different POS devices have different command settings, the way to send the command is the same. Command is sent by writing a series of bytes, which constitute a command that the device supports, to the device through a serial port, USB, or parallel port. Once the device 107 is detected, the client computer 104 then sends “Init/Reset” command to the device 107 (Step 7), which will then send back an ACK (Step 8). The client computer 104 then sends “read Pin” command to the device 107 (Step 9) and the device responds with ACK (Step 10). In response to this command, the device 107 prompts the user to enter PIN (Step 11). After the user enters a PIN and the PIN data is ready, the device 107 sends the PIN number in an encrypted block to the client computer 104 (Step 12) and the client computer 104 acknowledge it by sending an ACK (Step 13). The plug-in component 111 on the Virtual Terminal Page 106 will read this data from the receiving buffer. The client computer 104 then parses out the PIN block data from the device 107 (Step 14) and populates the fields on the Virtual Terminal Page 106 (Step 15) by running the JavaScript code on the Virtual Terminal Page 106. The client computer 104 then sends the data to the web server 101 for processing (Step 16). Finally, the web server 101 responds with a code of approval or a message of denial (Step 17).

Virtual Terminal device setup sequence is shown in FIG. 17. The client computer 104 launches a browser (Step 1) and sends a request to the web server 101 for the Virtual Terminal device setup page (Step 2). A cookie request is programmed in the page information sent to the browser 105 from the server 101. Cookie is used to store persistent information on the client computer 104 and can be accessed by both the browser 105 and the web server 101.

The client computer 104 loads the cookie containing information about the device hardware and setup configuration (Step 4), and sends it back to the server 101 (Step 5). Once the server 101 receives the cookie, it changes the device settings on the page to the information retrieved from the cookie (not shown in the figure). The server 101 then sends the client computer 104 the Virtual Terminal device setup page with the settings set in the selected cookie (Step 6). The client computer 104 then displays the device setup page to the user (Step 7) and the user may change the device setup page for the device manually (Step 8). If the user modifies the device setup page, the client computer 104 sends modified device setup page to the web server 101 (Step 9). In response, the web server 101 sends new cookie containing modified device setup page to the client computer 104, which saves it (Step 10). In order to ensure the cookie persists on the client computer 104, the expiration date of the cookie is set to indefinite.

The steps for processing a payment using a bi-directional POS device is substantially the same as the steps discussed for a unidirectional device, except that that step 5 is different. In step 5, an ActiveX component invoked by the Virtual Terminal Page 106 will interface with the POS device 107 directly using its native interface protocol, extract the data, and place it in appropriate data fields on the Virtual Terminal Page 106.

In those exemplary embodiments of the invention, specific components, arrangements, and assemble processes are used to describe the invention. Obvious changes, modifications, and substitutions may be made by those skilled in the art to achieve the same objective of the present invention. The exemplary embodiments are, of course, merely examples and are not intended to limit the scope of the invention. It is intended that the present invention cover all other embodiments that are within the scope of the appended claims and their equivalents.

What is claimed is:

1. A payment system comprising:
a server connecting to a first network using a communication protocol, the server being connected to banking network, the server hosting a virtual terminal application including a setup page and a plug-in component;
a computer, running an operating system, being connected to the first network using the same communication protocol used in the first network so that the computer and the server is able to exchange data bi-directionally;
a card reader being connected to the computer through its ports; and
a browser which runs in the computer, the computer being able to access the server to retrieve the virtual terminal application from the server;
Wherein, upon browser's accessing the Universal Resource Locator of the virtual terminal application, the server provisions the computer the virtual terminal application including the setup page and the plug-in component; upon being provisioned first time, the virtual terminal application automatically configures the card reader and stores the information about the card reader in a cookie in the computer; and the browser executes the plug-in component so that it allows the virtual terminal application to interface with the card reader.

2. The payment system of claim 1 wherein the virtual terminal application further comprises a program modules implementing a finite state automata method for parsing data from the card reader, wherein the virtual terminal application further comprises a credit card input page for entering payment data, and wherein the plug-in component is a JavaScript that is embedded in the virtual terminal application.

3. The payment system of claim 2 further comprising at least one device selected from the group consisting of receipt printer, barcode scanner, display pole, finger printer, and iris scanner, each being connected to the computer by using a working interface and being automatically configured first time upon the provision of the virtual terminal application.

4. The payment system of claim 1 wherein the payment system further contains a PIN pad connected to the computer for entering personal identification number, wherein the plug-in component further includes a binary executable, wherein the virtual terminal application further comprises a debit card input page for entering payment data, and wherein the virtual terminal application further comprises a program modules implementing a finite state automata method for parsing data from the card reader.

5. The payment system of claim 4 further comprising at least one device selected from the group consisting of receipt printer, barcode scanner, display pole, finger printer, and iris scanner, each being connected to the computer by using a working interface and being automatically configured first time upon the provision of the virtual terminal application.

6. The payment system of claim 1 further comprising at least one device selected from the group consisting of receipt printer, barcode scanner, display pole, finger printer, and iris scanner, each being connected to the computer by using a working interface and being automatically configured first time upon the provision of the virtual terminal application.

7. A payment system comprising:
a server connecting to a first network using a communication protocol, the server being connected to banking network, the server containing a virtual terminal application which include a setup page and a plug-in component;
a computer, run by an operating system, being connected to the first network using the same communication protocol used in the first network so that the computer and the server is able to exchange data bi-directionally;
a check reader and a signature-capturing pad being connected to the computer; and
a browser which runs in the computer, the computer being able to access the server to request the virtual terminal application from the server;
Wherein, upon the browser's accessing the Universal Resource Locator of the virtual terminal application, the server provisions the computer the virtual terminal application including the setup page and the plug-in component; upon being provisioned first time, the virtual terminal application automatically configures the check reader and stores the information about the check reader in a cookie in the computer; and the browser executes the plug-in component so that it allows the virtual terminal application to interface with the check reader and the signature-capturing pad.

8. The payment system of claim 7 wherein the virtual terminal application further comprising a check display page.

9. The payment system of claim 8 further comprising:
a check imager being connected to the computer; and
a digitally signed executable which supports bi-directional interface between the check imager and the computer, wherein the check imager is manually configured first time upon provision of the virtual terminal application and the information about the configuration is saved in a cookie in the computer.

10. The payment system of claim 9 further comprising at least one device selected from the group consisting of receipt printer, barcode scanner, display pole, finger printer, and iris scanner, each being connected to the computer by using a working interface and being automatically configured first time upon the provision of the virtual terminal application.

11. The payment system of claim 8 further comprising at least one device selected from the group consisting of receipt printer, barcode scanner, display pole, finger printer, and iris scanner, each being connected to the computer by using a working interface and being automatically configured first time upon the provision of the virtual terminal application.

12. The payment system of claim 7 further comprising:
a check imager being connected to the computer; and
a digitally signed executable which supports bi-directional interface between the check imager and the computer, wherein the check imager is manually configured first time upon provision of the virtual terminal application and the information about the configuration is saved in a cookie in the computer.

13. The payment system of claim 12 further comprising at least one device selected from the group consisting of receipt printer, barcode scanner, display pole, finger printer, and iris scanner, each being connected to the computer by using a working interface and being automatically configured first time upon the provision of the virtual terminal application.

14. The payment system of claim 7 further comprising at least one device selected from the group consisting of receipt printer, barcode scanner, display pole, finger printer, and iris scanner, each being connected to the computer by using a working interface and being automatically configured first time upon the provision of the virtual terminal application.

15. A payment system comprising:
a server connecting to a first network using a communication protocol, the server being connected to a banking network, the server containing a virtual terminal application including a setup page and an embedded plug-in component which includes an embedded JavaScript and a digitally signed executable binary;
a computer, run by an operating system, being connected to the first network using the same communication protocol used in the first network so that the computer and the server is able to exchange data bi-directionally;
a card reader and a check reader, each being connected the computer through a unidirectional interface enabled by the JavaScript;
a PIN pad and signature-capturing pad a being connected to the computer through a bi-directional interface enabled by the digitally signed binary executable; and
a browser running in the computer, the browser being able to access the server to retrieve the virtual terminal application from the server;
Wherein, upon the browser's accessing the Universal Resource Locator of the virtual terminal application, the server provisions the computer the virtual terminal application including the setup page and the plug-in component; upon being provisioned first time, the virtual terminal application automatically run the embedded JavaScript and configures the card reader and the check reader, and stores the information about the check reader and the check reader in a cookie in the computer; the virtual terminal application prompts the user of system to manually configure the PIN pad and signature-capturing pad and save the information about the PIN pad and the signature-capturing pad in the coolie in the computer.

16. The payment system of claim 15, wherein the virtual terminal application further comprises a check display page, the payment system further comprising a check imager being connected to the computer by a bi-directional interface run by the binary executable and being manually configured first time upon provision of the virtual terminal application.

17. The payment system of claim 15 further comprising a check imager being connected to the computer by a bi-directional interface run by the binary executable and being manually configured first time upon provision of the virtual terminal application.

18. The payment system of claim 17 further comprising at least one device selected from the group consisting of receipt printer, barcode scanner, display pole, finger printer, and iris scanner, each being connected to the computer by using a working interface and being configurable by the setup page.

19. The payment system of claim 15 further comprising at least one device selected from the group consisting of receipt printer, barcode scanner, display pole, finger printer, and iris scanner, each being connected to the computer by using a working interface and being configurable by the setup page.
